(19) United States
(12) Patent Application Publication
(10) Pub. No.: US 2004/0001660 A1
(43) Pub. Date: Jan. 1, 2004

(54) Crosstalk improvement module and its using method

(76) Inventors: Keisuke Asami, Shinshiro-shi (JP); Shosuke Miyaki, Hamamatsu-shi (JP)

Correspondence Address: FISH & RICHARDSON P.C., 45 ROCKEFELLER PLAZA, SUITE 2800, NEW YORK, NY, 10111, US

(21) Appl. No.: 10/600,395

(22) Filed: Jun. 20, 2003

(30) Foreign Application Priority Data
Jun. 28, 2002 (JP) P. 2002-190797

(51) Int. Cl. G02B 6/17

(52) U.S. Cl. 385/11

(57) ABSTRACT

It is to provide a crosstalk improvement module capable of achieving high stability of the optical output at ease, by improving the crosstalk in the final stage with the crosstalk values deteriorated, in the optical power meter and the light source of the polarization maintaining fiber (PMF) output. The crosstalk improvement module intervening between a first polarization maintaining fiber and a second polarization maintaining fiber, comprises a first lens for making an output light from the first polarization maintaining fiber a parallel light, a polarizer for converting the parallel light into a linearly polarized light, a splitter for splitting an output light of the polarizer, a second lens for concentrating one of the lights split by the splitter and supplying the split light to the second polarization maintaining fiber, and a photoreceptor for receiving the other light split by the splitter.

### BACKGROUND OF THE INVENTION

1. Field of the Invention

The present invention relates to an improvement of crosstalk of polarization maintaining fiber (PMF (Polarization-Maintaining-Fiber)) output.

2. Description of the Related Art

When manufacturing an optical power meter and a light source device of the polarization maintaining fiber (PMF) output, various kinds of optical components for use in the inside of the system need to conform to the polarization maintaining fiber (PMF).

In the case of cascading the various optical components (in serial) inside the system, crosstalk values at the final stage will be deteriorated because of crosstalk of various optical components cascaded and errors of optical core alignment at splicing portions such as connector splicing and fusion splicing.

Examples of the crosstalk improvement module as countermeasures against deterioration of the crosstalk values at the final stage in this system are described in FIG. 6 to FIG. 9.

FIG. 6 shows a first conventional example. A first lens 3, a polarizer (POLI) 4, and a second lens 5 are provided between a first polarization maintaining fiber (PMF) 1 and a second polarization maintaining fiber (PMF) 2.

In the first conventional example, since the polarizer (POL) is inserted, the crosstalk values are favorable, but the output optical power fluctuates disadvantageously.

FIG. 7 shows a second conventional example. A first lens 3, a beam splitter (BS) 6, and a second lens 5 are provided between the first polarization maintaining fiber (PMF) 1 and the second polarization maintaining fiber (PMF) 2, and the current of the light source, not illustrated, is controlled according to the output of a photo diode (PD) 7 which receives the light separated by the beam splitter.

The second conventional example can make the optical output power stable because the photo diode (PD) receives the optical output separated by the beam splitter (BS), thereby controlling the power, but the crosstalk values are deteriorated disadvantageously.

FIG. 8 shows a third conventional example. A first lens 3, a variable optical attenuator (VOA) 8, a beam splitter (BS) 6, and a second lens 5 are provided between the first polarization maintaining fiber (PMF) 1 and the second polarization maintaining fiber (PMF) 2, and the variable optical attenuator (VOA) is controlled according to the output of the photo diode (PD) 7 which receives the light separated by the beam splitter.

The third conventional example can make the optical output power stable because the photo diode (PD) receives the optical output separated by the beam splitter (BS) and the variable optical attenuator (VOA) controls the power, but the crosstalk values are deteriorated disadvantageously.

FIG. 9 shows a fourth conventional example. A first lens 3, a beam splitter (BS) 6, and a second lens 5 are provided between the first polarization maintaining fiber (PMF) 1 and the second polarization maintaining fiber (PMF) 2, and the current of the light source is controlled according to the output of the photo diode (PD), not illustrated, which receives the light separated by the beam splitter, through within a monitor fiber (SMF) 9.

The fourth conventional example can make the optical output power stable because the photo diode (PD) receives the optical output separated by the beam splitter (BS) through the monitor fiber (SMF), thereby controlling the power, but the crosstalk values are deteriorated disadvantageously.

In the conventional crosstalk improvement modules described in FIGS. 6 to 9, since the passage loss is greatly varied according to the polarization state of the incident light, the stable optical output for a long time cannot be obtained disadvantageously and it is difficult to manufacture the optical power meter and the light source of high crosstalk values.

### SUMMARY OF THE INVENTION

An object of the invention is to provide a crosstalk improvement module capable of achieving high stability of the optical output, by improving the crosstalk at the final stage with the crosstalk values deteriorated, in the optical power meter and the light source of the polarization maintaining fiber (PMF) output.

In order to solve the above problem, a crosstalk improvement module intervening between a first polarization maintaining fiber and a second polarization maintaining fiber, comprises:

a first lens for making an output light from the first polarization maintaining fiber a parallel light;

a polarizer for converting the parallel light into a linearly polarized light; a splitter for splitting an output light of the polarizer; a second lens for concentrating one of the lights split by the splitter and supplying the split light to the second polarization maintaining fiber; and a photoreceptor for receiving the other split light split by the splitter (a first aspect of the invention).

A crosstalk improvement module intervening between a first polarization maintaining fiber and a second polarization maintaining fiber, comprises: a first lens for making an output light from the first polarization maintaining fiber a parallel light;

a polarizer for converting the parallel light into a linearly polarized light; a splitter for splitting an output light of the polarizer; a second lens for concentrating one of the lights split by the splitter and supplying the split light to the second polarization maintaining fiber; and a monitor fiber for receiving the other split light split by the splitter (a second aspect of the invention).

It further comprises driving means for controlling the current of a light source to the first polarization maintaining fiber according to the output from the photoreceptor or the monitor fiber (a third aspect of the invention).

A crosstalk improvement module intervening between a first polarization maintaining fiber and a second polarization maintaining fiber, comprises:

a first lens for making an output light from the first polarization maintaining fiber a parallel light;

a polarizer for converting the parallel light into a linearly polarized light; a splitter for splitting an output light of the polarizer; a second lens for concentrating one of the lights split by the splitter and supplying the split light to the second polarization maintaining fiber; a photoreceptor for receiving the other light split by the splitter; and a variable optical attenuator, provided in a front stage or a rear stage of the polarizer, for varying an input light, wherein the variable optical attenuator is controlled according to an output from the photoreceptor (a fourth aspect of the invention).

It is constituted in that the first polarization maintaining fiber is connected to an input terminal of the crosstalk improvement module by a receptacle (a fifth aspect of the invention).

It is constituted in that an optical component conforming to the polarization maintaining fiber is connected in a final stage of a system cascading a plurality of stages (a sixth aspect of the invention).

### BRIEF DESCRIPTION OF THE DRAWINGS

FIG. 1 is a view showing the first structural example of the crosstalk improvement module of the invention.

FIG. 2 is a view showing the second structural example of the crosstalk improvement module of the invention.

FIG. 3 is a view showing the third structural example of the crosstalk improvement module of the invention.

FIG. 4 is a view showing the fourth structural example of the crosstalk improvement module of the invention.

FIG. 5 is a view showing the fifth structural example of the crosstalk improvement module of the invention.

FIG. 6 is a view showing the first structural example of the conventional crosstalk improvement module.

FIG. 7 is a view showing the second structural example of the conventional crosstalk improvement module.

FIG. 8 is a view showing the third structural example of the conventional crosstalk improvement module.

FIG. 9 is a view showing the fourth structural example of the conventional crosstalk improvement module.

FIG. 10 is a view showing the first example of the use of the crosstalk improvement module of the invention.

FIG. 11 is a view showing the second example of the use of the crosstalk improvement module of the invention.

### DESCRIPTION OF THE EMBODIMENTS

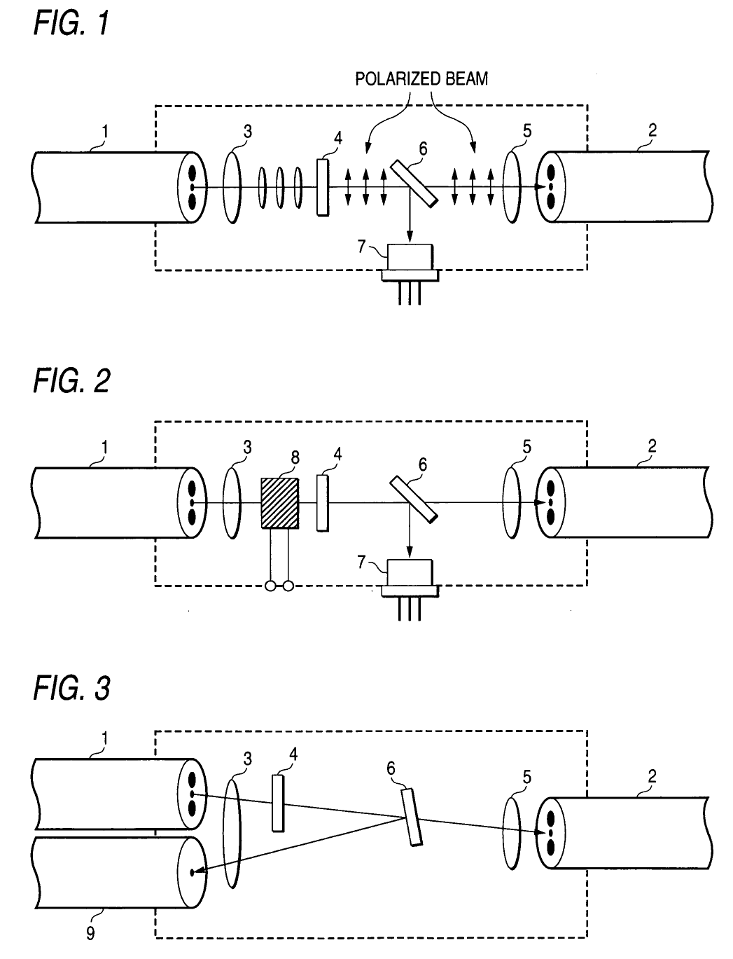

By using FIGS. 1 to 5, the structure of a crosstalk improvement module of the invention will be described in detail.

In FIGS. 1 to 5, each portion surrounded by a dotted line indicates each crosstalk improvement module.

FIG. 1 is a view showing the structure of the first embodiment of the invention.

In FIG. 1, a first lens 3, a polarizer (POL) 4, a beam splitter (BS) 6, and a second lens 5 are provided between the first polarization maintaining fiber (PMF) 1 and the second polarization maintaining fiber (PMF) 2, and the current of the light source, not illustrated, is controlled according to the output of a photo diode (PD) 7 which receives the light separated from the beam splitter (BS) 6.

In the above first embodiment, since the polarizer (POL) 4 is inserted there, it is possible to improve the crosstalk and make the optical output power stable because the power can be controlled according to the output of the photo diode (PD) 7 which receives the light.

FIG. 2 is a view showing the structure of a second embodiment of the invention.

In FIG. 2, a first lens 3, a variable optical attenuator (VOA) 8, a polarizer (POL) 4, a beam splitter (BS) 6, and a second lens 5 are provided between the first polarization maintaining fiber (PMF) 1 and a second polarization maintaining fiber (PMF) 2. The variable optical attenuator (VOA) 8 controls the power, according to the output of the photo diode (PD) 7 which receives the light separated from the beam splitter (BS) 6.

In the second embodiment, since the polarizer (POL) 4 is inserted, it is possible to improve the crosstalk and make the optical output power stable because the variable optical attenuator (VOA) 8 can control the power according to the output of the photo diode (PD) 7 which receives the light.

FIG. 3 is a view showing the structure of a third embodiment of the invention.

In FIG. 3, a first lens 3, a polarizer (POL) 4, a beam splitter (BS) 6, and a second lens 5 are provided between the first polarization maintaining fiber (PMF) 1 and the second polarization maintaining fiber (PMF) 2. The light separated from the beam splitter (BS) 6 is given to the monitor fiber (SMF) 9, and the variable optical attenuator (VOA) controls the power, according to the output of the photo diode (PD) 7, not illustrated, which receives the output of the monitor fiber 9.

In the third embodiment, since the polarizer (POL) 4 is inserted there, it is possible to improve the crosstalk and make the optical output power stable because the variable optical attenuator can control the power according to the output of the photo diode (PD) 7 which receives the light through the monitor fiber 9.

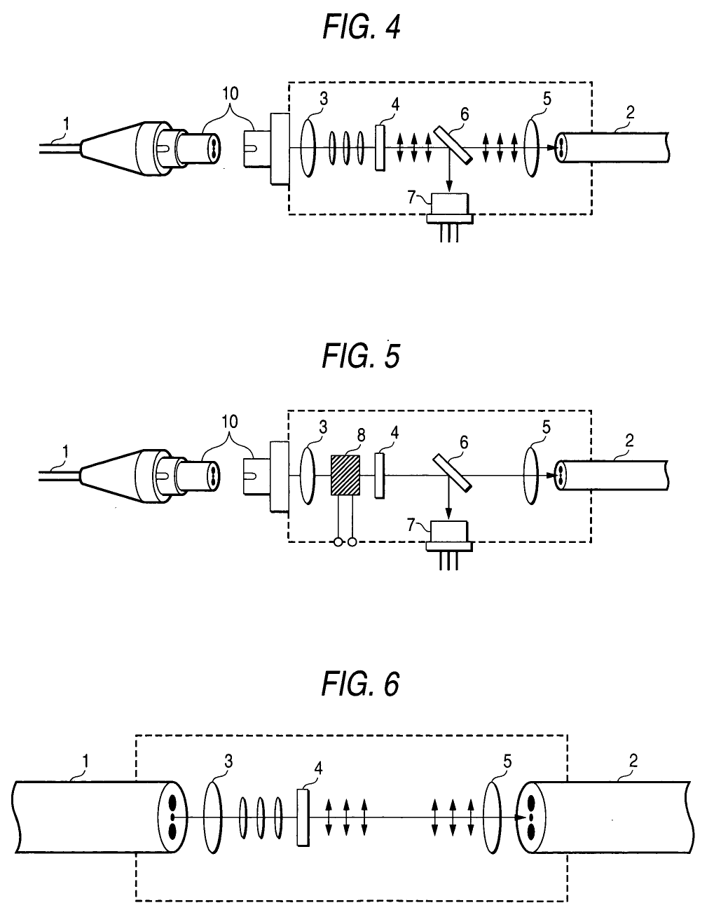

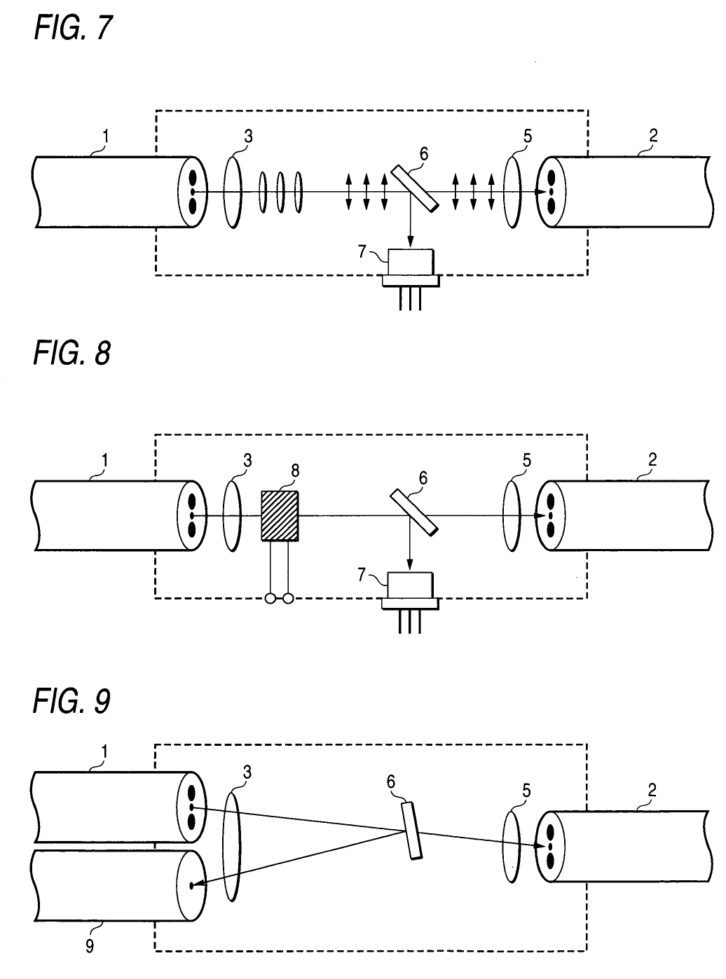

FIG. 4 is a view showing the structure of a fourth embodiment of the invention.

In FIG. 4, a receptacle 10, a first lens 3, a polarizer (POL) 4, a beam splitter (BS) 6, and a second lens 5 are provided between the first polarization maintaining fiber (PMF) 1 and the second polarization maintaining fiber (PMF) 2. The current of the light source, not illustrated, is controlled according to the output of the photo diode (PD) 7 which receives the light separated by the beam splitter (BS) 6.

In the fourth embodiment, since the receptacle 10 can connect the first polarization maintaining fiber (PMF) 1 to the crosstalk improvement module easily and the polarizer (POL) 4 is inserted into the module, it is possible to improve the crosstalk and make the optical output power stable because the power is controlled according to the output of the photo diode (PD) 7 which receives the light.

FIG. 5 is a view showing the structure of a fifth embodiment of the invention.

In FIG. 5, a receptacle 10, a first lens 3, a variable optical attenuator (VOA) 8, a polarizer (POL) 4, a beam splitter (BS) 6, and a second lens 5 are provided between the first polarization maintaining fiber (PMF) 1 and the second polarization maintaining fiber (PMF) 2. The variable optical attenuator (VOA) 8 is controlled according to the output of the photo diode (PD) 7 which receives the light separated from the beam splitter (BS) 6.

In the fifth embodiment, since the receptacle 10 can connect the first polarization maintaining fiber (PMF) 1 to the crosstalk improvement module easily and the polarizer (POL) 4 is inserted into the module, it is possible to improve the crosstalk and make the optical output power stable because the vertical optical attenuator (VOA) controls the power according to the output of the photo diode (PD) 7 which receives the light.

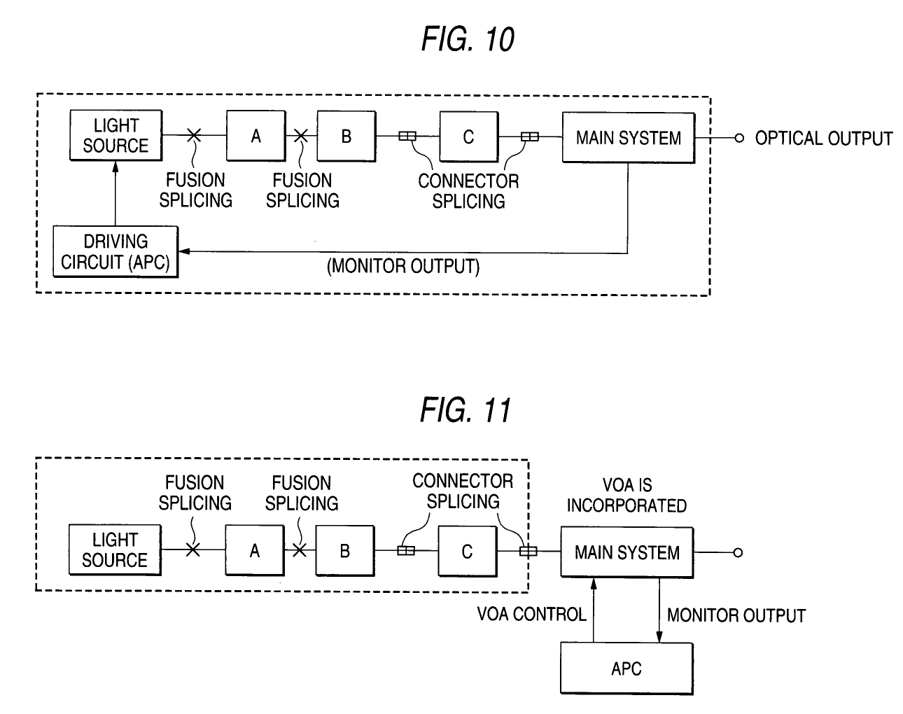

By using FIG. 10 and FIG. 11, the form of using the crosstalk improvement module of the invention will be described.

FIG. 10 shows the first example of its use. In FIG. 10, various kinds of optical components (light source and various kinds of optical components A, B, and C) for use in the optical power meter and the light source (the portion indicated by a dotted line in FIG. 10) of the polarization maintaining fiber (PMF) output conform to the polarization maintaining fiber (PMF).

In FIG. 10, fusion splicing and connector splicing are performed between various kinds of optical components, the crosstalk improvement module shown as this system in FIG. 1, FIG. 3, or FIG. 4 is connected in the final stage, and the current of the light source is controlled through the driving circuit (APC) according to the monitor output from the crosstalk improvement module.

FIG. 11 shows the second example of its use. In FIG. 11, various kinds of optical components (light source and various kinds of optical components A, B, and C) for use in the optical power meter and the light source (the portion indicated by a dotted line in FIG. 11) of the polarization maintaining fiber (PMF) output conform to the polarization maintaining fiber (PMF).

In FIG. 11, fusion splicing and connector splicing are performed between various kinds of optical components, the crosstalk improvement module shown as this system in FIG. 2 or FIG. 5 is connected in the outside of the optical components, and the variable optical attenuator (VOA) incorporated therein is controlled according to the monitor output from the crosstalk improvement module.

According to the first aspect of the invention, since the crosstalk improvement module intervening between the first polarization maintaining fiber and the second polarization maintaining fiber, comprises a first lens for making an output light from the first polarization maintaining fiber a parallel light, a polarizer for converting the parallel light into a linearly polarized light, a splitter for splitting an output light of the polarizer, a second lens for concentrating one of the lights split by the splitter and supplying the split light to the second polarization maintaining fiber, and a photoreceptor for receiving the other split light split by the splitter, it is possible to easily obtain the crosstalk improvement module capable of obtaining high stability of optical output by improving the crosstalk in the final stage with the crosstalk values deteriorated, in the optical power meter and the light source of the polarization maintaining fiber (PMF) output.

According to the second aspect of the invention, since the crosstalk improvement module intervening between the first polarization maintaining fiber and the second polarization maintaining fiber, comprises a first lens for making an output light from the first polarization maintaining fiber a parallel light, a polarizer for converting the parallel light into a linearly polarized light, a splitter for splitting an output light of the polarizer, a second lens for concentrating one of the lights split by the splitter and supplying the split light to the second polarization maintaining fiber, and a monitor fiber for receiving the other light split by the splitter, it is possible to obtain the crosstalk improvement module capable of obtaining high stability of optical output at ease, by improving the crosstalk in the final stage with the crosstalk values deteriorated, in the optical power meter and the light source of the polarization maintaining fiber (PMF) output, instead of providing a photoreceptor such as a photo diode in the module.

According to the third aspect of the invention, since the crosstalk improvement module comprises the driving means for controlling the current of the light source to the first polarization maintaining fiber according to the output from the photoreceptor or the monitor fiber, the same module can be easily adopted to a system capable of varying the current of the light source.

According to the fourth aspect of the invention, since the crosstalk improvement module intervening between the first polarization maintaining fiber and the second polarization maintaining fiber comprises a first lens for making an output light from the first polarization maintaining fiber a parallel light, a polarizer for converting the parallel light into a linearly polarized light, a splitter for splitting an output light of the polarizer, a second lens for concentrating one of the lights split by the splitter and supplying the split light to the second polarization maintaining fiber, a photoreceptor for receiving the other split light split by the splitter, and a variable optical attenuator, provided in a front stage or a rear stage of the polarizer, for varying an input light, wherein the variable optical attenuator is controlled according to the output from the photoreceptor, the same module can be easily adopted to a system incapable of adjusting the current of the light source.

In the fifth aspect of the invention, the first polarization maintaining fiber can be connected to the input terminal of the crosstalk improvement module by a receptacle, thereby making the connection easy.

The sixth aspect of the invention is especially effective in the case of connecting an optical component conforming to the polarization maintaining fiber in the final stage of a system cascading a plurality of stages.

What is claimed is:

1. A crosstalk improvement module intervening between a first polarization maintaining fiber and a second polarization maintaining fiber, comprising:
a first lens for making an output light from the first polarization maintaining fiber a parallel light;
a polarizer for converting the parallel light into a linearly polarized light;
a splitter for splitting an output light of the polarizer;
a second lens for concentrating one of the lights split by the splitter and supplying the split light to the second polarization maintaining fiber; and
a photoreceptor for receiving the other split light split by the splitter.

2. A crosstalk improvement module intervening between a first polarization maintaining fiber and a second polarization maintaining fiber, comprising:
a first lens for making an output light from the first polarization maintaining fiber a parallel light;
a polarizer for converting the parallel light into a linearly polarized light;
a splitter for splitting an output light of the polarizer;
a second lens for concentrating one of the lights split by the splitter and supplying the split light to the second polarization maintaining fiber; and
a monitor fiber for receiving the other split light split by the splitter.

3. The crosstalk improvement module, according to claim 1 or 2, comprising
driving means for controlling a current of a light source to the first polarization maintaining fiber according to an output from the photoreceptor or the monitor fiber.

4. A crosstalk improvement module intervening between a first polarization maintaining fiber and a second polarization maintaining fiber, comprising:
a first lens for making an output light from the first polarization maintaining fiber a parallel light;
a polarizer for converting the parallel light into a linearly polarized light;
a splitter for splitting an output light of the polarizer;
a second lens for concentrating one of the lights split by the splitter and supplying the split light to the second polarization maintaining fiber;
a photoreceptor for receiving the other light split by the splitter; and
a variable optical attenuator, provided in a front stage or a rear stage of the polarizer, for varying an input light, wherein the variable optical attenuator is controlled according to an output from the photoreceptor.

5. The crosstalk improvement module, according to claims 1 to 4, wherein
the first polarization maintaining fiber is connected to an input terminal of the crosstalk improvement module by a receptacle.

6. The crosstalk improvement module, according to claims 1 to 5, wherein
an optical component conforming to the polarization maintaining fiber is connected in a final stage of a system cascading a plurality of stages.
